(19) United States
(12) Patent Application Publication
(10) Pub. No.: US 2016/0204999 A1
(43) Pub. Date: Jul. 14, 2016

(54) MONITORING APPARATUS AND INFORMATION PROCESSING SYSTEM

(71) Applicant: FUJITSU LIMITED, Kawasaki-shi (JP)

(72) Inventors: Mikayo KOSUGI, Yokohama (JP); Keiko Takeuchi, Kawasaki (JP)

(73) Assignee: FUJITSU LIMITED, Kawasaki-shi (JP)

(21) Appl. No.: 14/957,751

(22) Filed: Dec. 3, 2015

(30) Foreign Application Priority Data
Jan. 13, 2015 (JP) 2015-004203

(51) Int. Cl. H04L 12/26; G06F 9/46

(52) U.S. Cl. CPC H04L 43/045; H04L 43/14; G06F 9/46

(57) ABSTRACT

A monitoring apparatus includes one or more processors configured to execute a plurality of monitoring processes generated for a plurality of monitoring target information processing apparatuses and communication processes generated by a count smaller than a number of the plurality of monitoring target information processing apparatuses, wherein each of the plurality of monitoring processes causes the one or more processors to register an instruction of collecting information from a monitoring target information processing apparatus in a queue, and each of the communication processes causes the one or more processors to read the instruction registered in the queue, to collect monitored information from the monitoring target information processing apparatus, and to write the monitored information into a storage unit.

### CROSS-REFERENCE TO RELATED APPLICATION

This application is based upon and claims the benefit of priority of the prior Japanese Patent Application No. 2015-004203, filed on Jan. 13, 2015, the entire contents of which are incorporated herein by reference.

### FIELD

The embodiments discussed herein are related to a monitoring apparatus and an information processing system.

### BACKGROUND

Over the recent years, vertically integrated system products have emerged, the products being attained by clustering Information and Communication Technology (ICT) devices to integrate management software and business applications. As in the case of a large-scale system environment configured to include a plurality of servers interconnected via a network such as the vertically integrated system, respective servers are monitored by periodically collecting information from these servers.

A monitoring apparatus to monitor each server generates threads by a count corresponding to a number of monitoring target servers. The “thread” may be defined as an execution unit of a program. The thread communicates with the monitoring target server in a one-to-one relationship, and collects information of the monitoring target server. The thread collecting the information of the monitoring target server has a larger memory usage quantity and a higher communication load than a thread not performing the communications. Accordingly, the memory usage quantity rises in proportion to an increase in number of monitoring target servers.

### PATENT DOCUMENTS

[Patent Document 1] Japanese Laid-Open Patent Publication No. 2002-7334
[Patent Document 2] Japanese Laid-Open Patent Publication No. H09-330302
[Patent Document 3] Japanese Laid-Open Patent Publication No. H05-75621

### SUMMARY

According to an aspect of the embodiments, a monitoring apparatus includes one or more processors configured to execute a plurality of monitoring processes generated for a plurality of monitoring target information processing apparatuses and communication processes generated by a count smaller than a number of the plurality of monitoring target information processing apparatuses, wherein each of the plurality of monitoring processes causes the one or more processors to register an instruction of collecting information from a monitoring target information processing apparatus in a queue, and each of the communication processes causes the one or more processors to read the instruction registered in the queue, to collect monitored information from the monitoring target information processing apparatus, and to write the monitored information into a storage unit.

The object and advantages of the invention will be realized and attained by means of the elements and combinations particularly pointed out in the claims. It is to be understood that both the foregoing general description and the following detailed description are exemplary and explanatory and are not restrictive of the invention.

### BRIEF DESCRIPTION OF THE DRAWINGS

FIG. 1 is a diagram illustrating one example of a whole of system management method;

FIG. 2A is a diagram illustrating one example of an initializing flow by the system management method;

FIG. 2B is a diagram illustrating one example of a screen deployment flow by the system management method;

FIG. 3 is a diagram illustrating one example of a configuration of a monitoring apparatus in a comparative example;

FIG. 4 is a diagram illustrating an operational example of acquiring server information for the first time in the comparative example;

FIG. 5 is a diagram illustrating an operational example of acquiring the server information from second time onward in the comparative example;

FIG. 6 is a diagram illustrating one example of a hardware configuration of the monitoring apparatus;

FIG. 7 is a diagram illustrating a configuration of functions of the monitoring apparatus in an information processing system;

FIG. 8 is a diagram illustrating an operational example of acquiring the server information for the first time;

FIG. 9 is a diagram illustrating an operational example when a Worker thread count reaches an upper limit value in acquiring the server information for the first time;

FIG. 10 is a diagram illustrating an operational example of acquiring the server information from second time onward;

FIG. 11 is a diagram depicting one example of a data structure of a thread management table;

FIG. 12 is a diagram depicting one example of a data structure of a performance information storage table;

FIG. 13 is a diagram depicting one example of a data structure of an entry registered in a queue;

FIG. 14 is a diagram depicting one example of a data structure of information to be received and transferred between threads;

FIG. 15 is a flowchart illustrating one example of a process of a Main thread;

FIG. 16 is a flowchart illustrating one example of a process of a Monitor thread;

FIG. 17 is a flowchart illustrating one example of a connecting information update process of the Monitor thread;

FIG. 18 is a flowchart illustrating one example of a process of a Worker thread;

FIG. 19 is a diagram illustrating a modified example 1 in which the monitoring target server is associated by the Monitor thread by a serial number;

FIG. 20 is a diagram illustrating a modified example 2 in which the monitoring target server includes a plurality of Operating Systems (OSs); and

FIG. 21 is a flowchart illustrating one example of a process of the Worker thread in the modified example 2.

### DESCRIPTION OF EMBODIMENTS

Memory resources to be allocated to software are limited. Therefore, when the memory usage quantity exceeds a memory quantity allocated to the software, the memory becomes depleted. The depletion of the memory results in stopping an operation of the software as the case may be.

A softwarewise memory usage quantity rises in proportion to the increase in number of monitoring target servers, and hence the number of monitoring target servers is limited within a range of the allocated memory resources.

Further, the thread generated per monitoring target server occupies the memory during the monitoring. The thread is generated per monitoring target server, and the load rises due to use of the memory and the communications, in which case the resources to be allocated to other processes are reduced.

An embodiment of the present invention will hereinafter be described based on the drawings. A configuration of the following embodiment is an exemplification, and the present invention is not limited to the configuration of the embodiment.

<System Management Method>

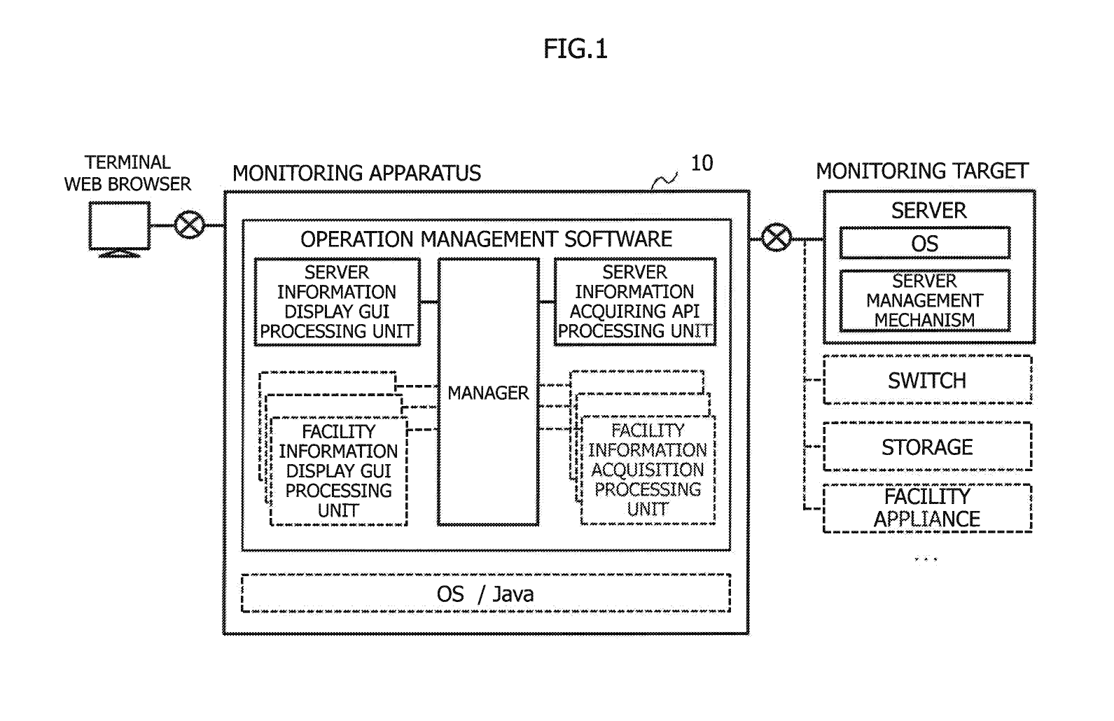

In a large-scale system environment configured to include a plurality of servers, a monitoring apparatus periodically collects information from a monitoring target server and other equivalent apparatuses connected to a network, thus monitoring states. FIG. 1 depicts one example of a whole diagram of the system management method.

In FIG. 1, a system includes a terminal, a monitoring apparatus, a monitoring target server, and other equivalent apparatuses. The monitoring target apparatus includes, in addition to the server, a switch, storage, facility equipment, and other equivalent apparatuses. The terminal requests the monitoring apparatus to acquire server information through a Web browser.

The monitoring apparatus is preinstalled with programs instanced by operation management software, Operating System (OS), Java (registered trademark) software. The operation management software includes a server information display Graphical User Interface (GUI) processing unit, a manager, and a server information acquiring API (Application Programming Interface) processing unit. The operation management software further includes GUI processing units and information acquisition processing units for other facility equipment.

The monitoring target server includes OS and a server management mechanism. The OS provides the monitoring apparatus with information on server performance. The server management mechanism operates independently of the server and the OS, and provides the monitoring apparatus with a server serial number in addition to the server's states instanced by a temperature, a power source and other equivalent states.

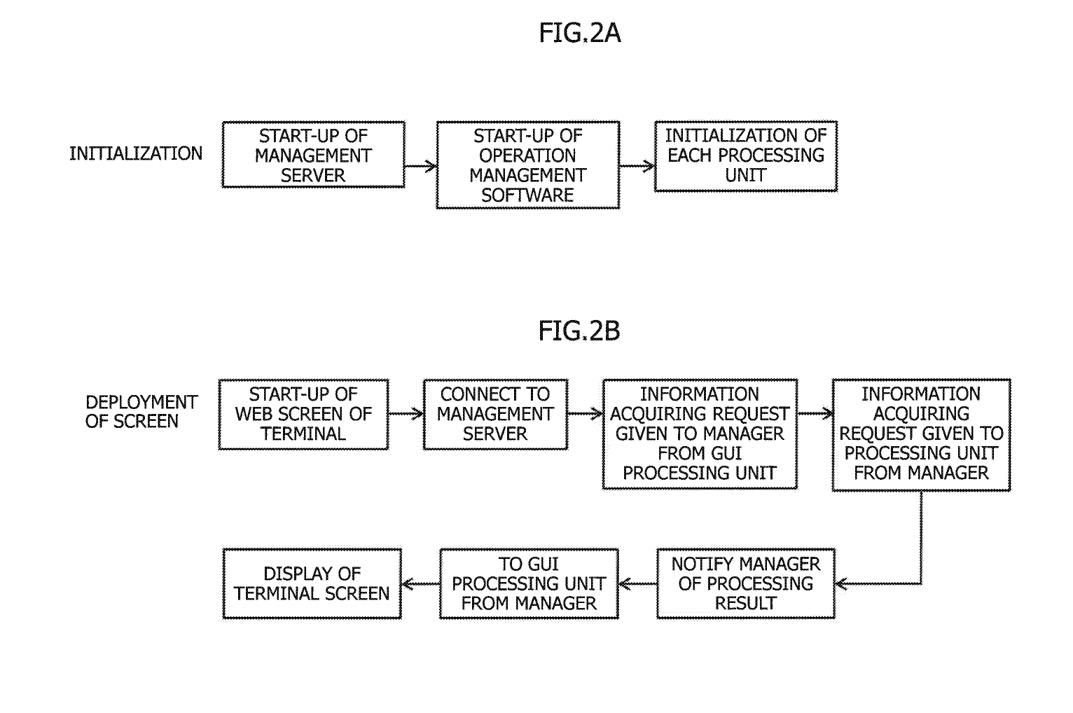

FIGS. 2A and 2B are diagrams each illustrating an entire flow of the system management method. The system management method includes a flow of initializing the system for acquiring the server information and other equivalent information, and a flow of deploying a screen in response to an information acquiring instruction given from a user.

FIG. 2A depicts one example of the initializing flow in the system management method. A start of the initializing flow is triggered by booting the monitoring apparatus. Next, the monitoring apparatus starts up the operation management software. Subsequently, the monitoring apparatus initializes the respective processing units, i.e., the server information display GUI processing unit, the server information acquiring API processing unit and other equivalent units. On the occasion of the initialization, the server information display GUI processing unit reads a setting file that is set by the user, and acquires setting information used for acquiring the server information. The respective processing units are finished upon a termination of a service based on the operation management software.

FIG. 2B illustrates one example a screen deployment flow in the system management method. A start of the screen deployment flow is triggered by starting up a Web screen on the terminal. Next, the Web screen connects with the monitoring apparatus to request the monitoring apparatus to acquire the server information. Each of the GUI processing units of the operation management software on the monitoring apparatus requests the manager to acquire the information. The manager requests each information acquisition processing unit to collect the information. Each information acquisition processing unit notifies the manager of a processing result about the information collected from the server. The manager notifies each GUI processing unit of the processing result. Each GUI processing unit notifies the terminal of the processing result. The terminal displays the processing result on the screen.

### COMPARATIVE EXAMPLE

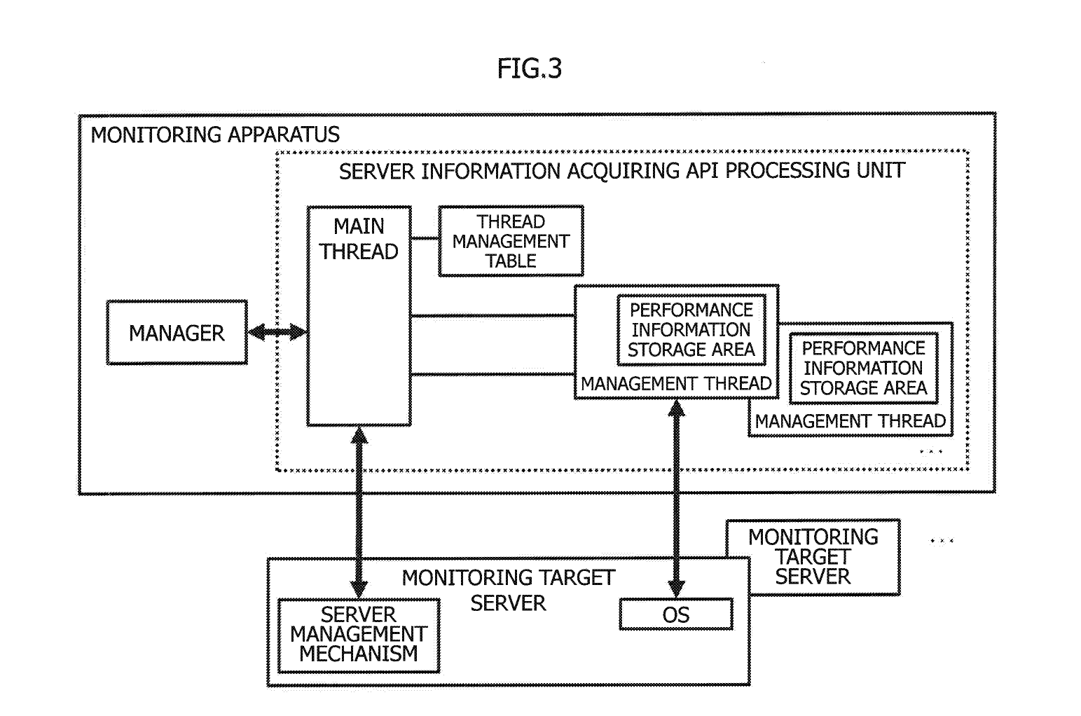

FIG. 3 illustrates one example of a diagram of a configuration of the monitoring apparatus in a comparative example. In FIG. 3, the monitoring apparatus includes a manager and a server information acquiring API processing unit. The monitoring apparatus monitors a plurality of monitoring target servers. The monitoring target server is the same as the monitoring target server in FIG. 1, and hence its explanation is omitted.

The monitoring apparatus includes a Main thread, a thread management table and a management thread. There exist the same numbers of management threads as the number of the monitoring target servers. The Main thread receives a request from the manager, and controls whole processes of the server information acquiring API processing unit. The thread management table stores information to manage links between the monitoring target servers and the management threads. The management thread is generated in a one-to-one relationship with the monitoring target server, and periodically collects the information from the monitoring target server. The management thread contains a performance information storage area. The management thread retains the information collected from the monitoring target server in the performance information storage area.

The management thread manages connection information with the server, establishes a connection, collects the information, makes a compilation, and manages generations per monitoring target server. Items of performance information of the respective monitoring target servers are collected at a fixed interval originating from a first connection with the manager, and are therefore processed in parallel per monitoring target server. Hence, the management threads for collecting the performance information exist in a one-to-one relationship with the monitoring target server.

When the monitoring target server is a virtual machine implemented by, e.g., VMware, the monitoring apparatus uses open source software interface (application Interface, API) provided with VMware for acquiring the information from the VMware. The monitoring apparatus generates a VimPortType object having a larger size than an ordinary object. The management thread having the VimPortType object in the one-to-one relationship with the monitoring target server is generated, at which time a memory usage quantity of the monitoring apparatus increases in proportion to a monitoring target server count, and such a possibility occurs as to exceed a size of usable heap memory area.

In the comparative example, the collected information is retained within the management thread, and hence, when receiving a request for acquiring the server information from the user, it takes a considerable period of time to search for the management thread retaining the target server information. Consequently, this leads to an elongated period of time till returning a result of acquiring the server information as the case may be.

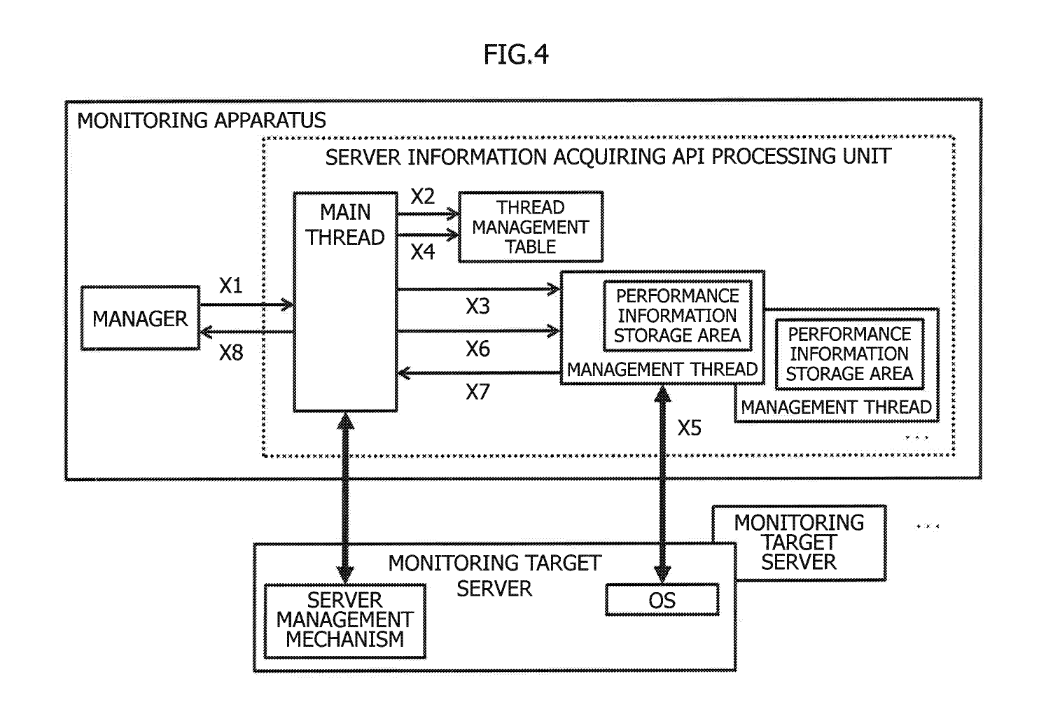

FIG. 4 is a diagram illustrating an operational example of acquiring the server information for the first time in the comparative example. The manager requests the Main thread to acquire the server information (X1). The Main thread searches the thread management table for the monitoring target server (X2). The monitoring target server is not registered in the thread management table when accessed for the first time. Therefore, the Main thread generates and starts the management thread for the monitoring target server (X3). The Main thread registers a link between the monitoring target server and the generated management thread in the thread management table (X4). The management thread collects the performance information by communicating with the monitoring target server, and retains the performance information in the performance information storage area (X5). The Main thread requests the management thread to fetch the performance information (X6). The management thread notifies the Main thread of the performance information fetched from the performance information storage area (X7). The Main thread returns the notified performance information as the server information to the manager (X8).

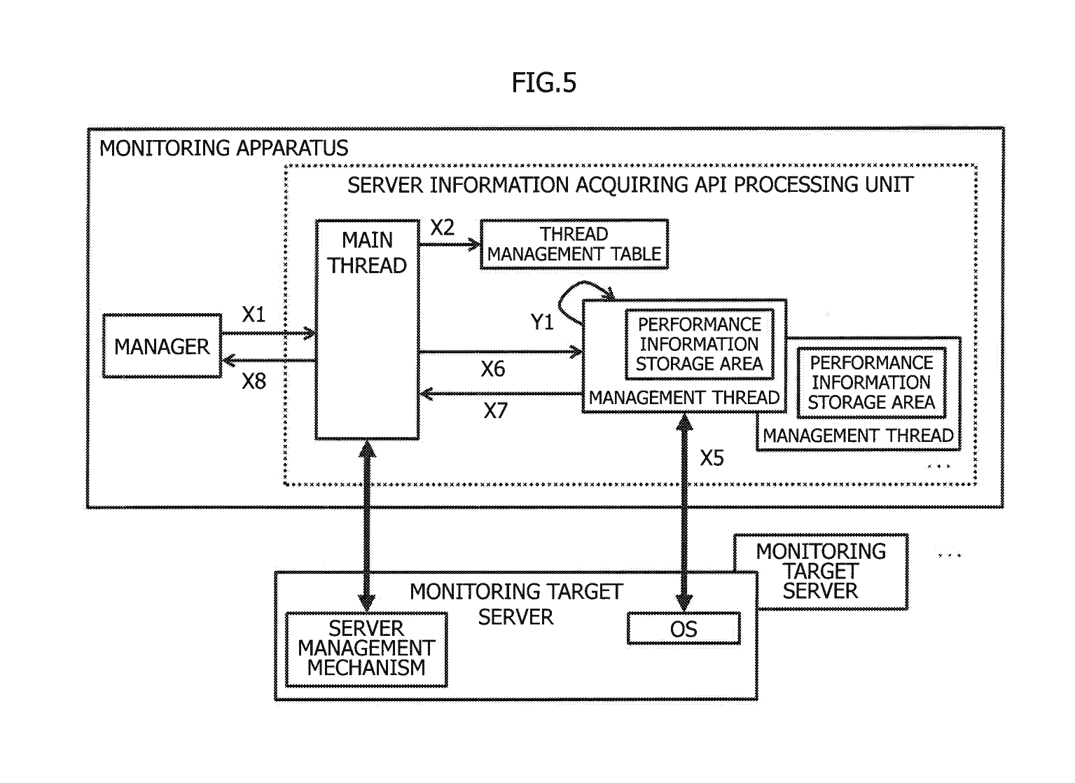

FIG. 5 is a diagram illustrating an operational example of acquiring the server information from a second time onward in the comparative example. In a process of acquiring the server information from the second time onward, the management thread for the monitoring target server will have already been generated. Therefore, the Main thread does not execute processes of generating and starting the management thread (X3 in FIG. 4), and making the registration in the thread management table (X4 in FIG. 4).

The same processes in FIG. 5 as the processes in FIG. 4 are marked with the same numerals and symbols, and their explanations are omitted. The management thread periodically collects the information, and retains the collected information in the performance information storage area (Y1).

### Embodiment

In the embodiment, the management thread for managing the monitoring target server is divided into a Monitor thread and a Worker thread. The Monitor thread controls the instruction for acquiring the server information from the monitoring target server. The Worker thread collects the server information from the monitoring target server. The collection of the server information involves a communication process and therefore has a higher load than the process of the Monitor thread. The present embodiment is contrived to reduce a load on the monitoring apparatus by restricting a number of Worker threads. Note that the server information is one example of monitored information. The server information contains, e.g., the performance information of the monitoring target server.

<Configuration of Apparatus>

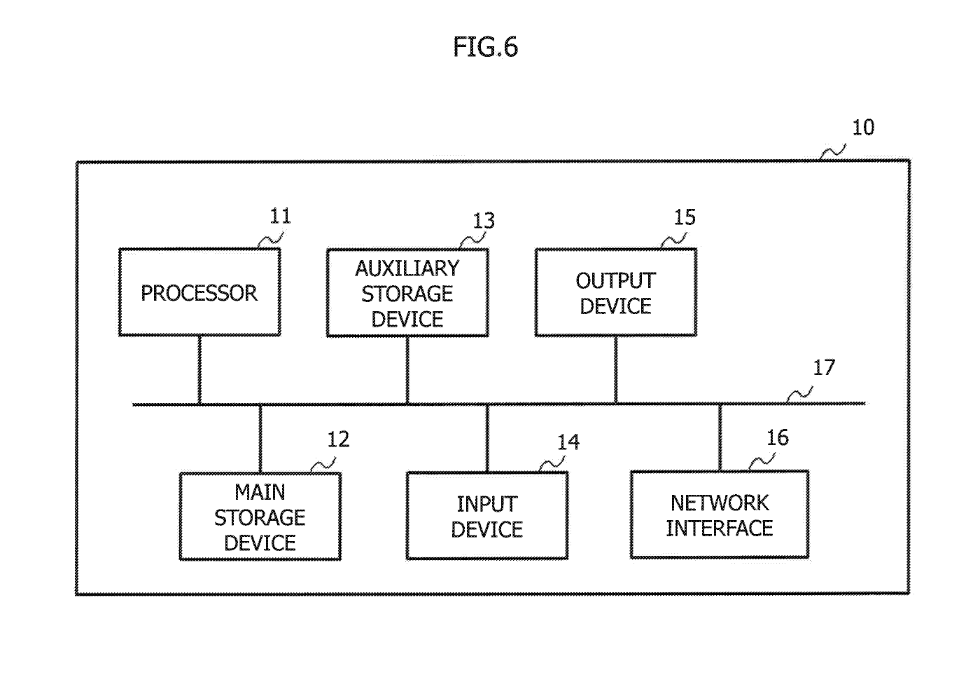

FIG. 6 is a diagram illustrating one example of a hardware configuration of a monitoring apparatus 10. The monitoring apparatus 10 includes a processor 11, a main storage device 12, an auxiliary storage device 13, an input device 14, an output device 15 and a network interface 16. These components are interconnected via a bus 17.

The processor 11 executes a variety of processes by loading the OS and various categories of computer programs retained on the auxiliary storage device 13 into the main storage device 12, and executing these software components. However, a part of the processes based on the computer programs may be executed by a hardware circuit. The processor 11 is exemplified by a CPU (Central Processing Unit) and a DSP (Digital Signal Processor).

The main storage device 12 provides a storage area for the processor 11 to load the programs stored in the auxiliary storage device 13, and an operation area for the processor 11 to execute the programs. The main storage device 12 is used as a buffer for retaining the data. The main storage device 12 is a semiconductor memory instanced by a Read Only Memory (ROM), a Random Access Memory (RAM) and other equivalent memories.

The auxiliary storage device 13 stores the various categories of programs and the data to be used by the processor 11 when executing the respective programs. The auxiliary storage device 13 is exemplified by nonvolatile memory instanced by an Erasable Programmable ROM (EPROM) or a Hard Disk Drive (HDD) and other equivalent storages. The auxiliary storage device 13 retains, e.g., the OS, a monitoring program and other various application programs.

The input device 14 accepts an operation input from the user. The input device 14 is exemplified by a pointing device instanced by a touch pad, a mouse and a touch panel, a circuit to receive a signal from a keyboard, an operation button and a remote controller, and other equivalent devices. The output device 15 outputs a content of recovery scenario redefined by the monitoring apparatus 10. The output device 15 is exemplified by an LCD (Liquid Crystal Display). The output device 15 is one example of a display.

The network interface 16 is an interface for inputting and outputting the information to and from a network. The network interface 16 includes an interface connecting with a cable network and an interface connecting with a wireless network. The network interface 16 is exemplified by a NIC (Network Interface Card), a wireless LAN (Local Area Network) card, and other equivalent interfaces. The data and other equivalent information received by the network interface 16 are output to the processor 11.

For example, in the monitoring apparatus 10, the processor 11 loads a management program retained in the auxiliary storage device 13 into the main storage device 12, and executes the management program. Note that the hardware configuration of the monitoring apparatus 10 is one example, and, without being limited to the configuration described above, components of the configuration may be properly omitted, replaced and added corresponding to the embodiment.

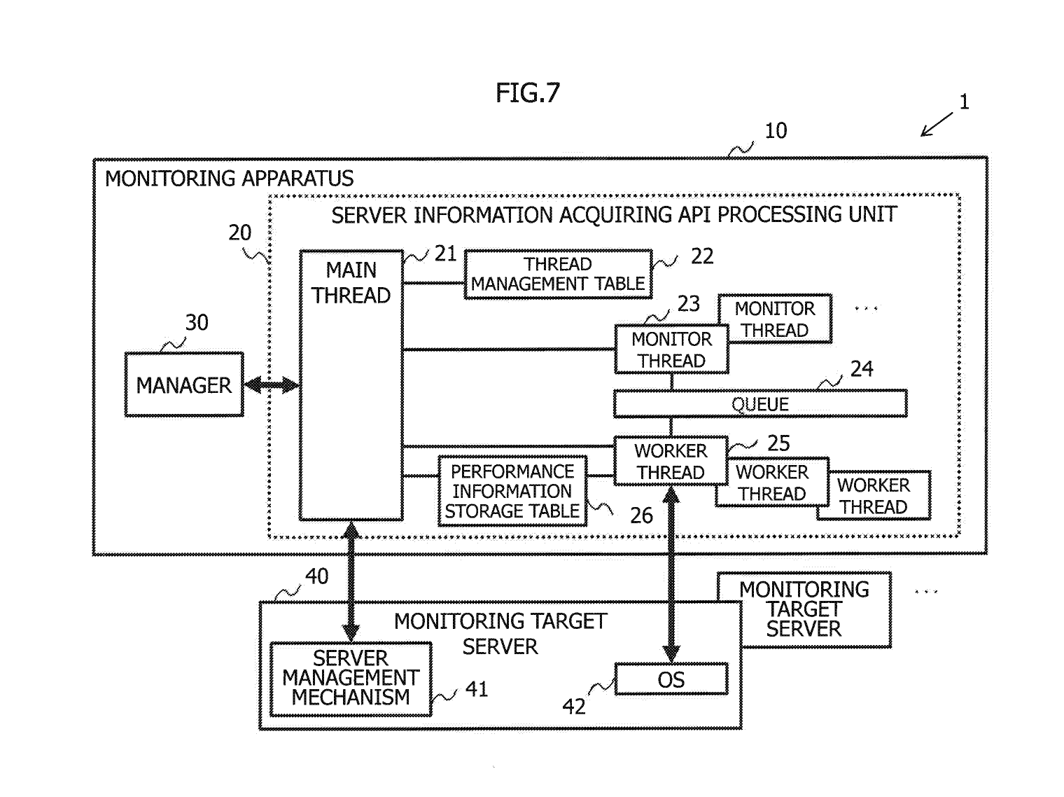

FIG. 7 is a diagram illustrating one example of a configuration of functions of the monitoring apparatus 10 in the information processing system 1. The information processing system 1 includes the monitoring apparatus 10 and a plurality of monitoring target servers 40. The information processing system 1 may also be a large-scale system including 1,000 or more monitoring target servers 40. The monitoring target server 40 is one example of a monitoring target information processing apparatus.

The monitoring apparatus 10 includes a server information acquiring API processing unit 20 and a manager 30. The server information acquiring API processing unit 20 includes a Main thread 21, a thread management table 22, a Monitor thread 23, a queue 24, a Worker thread 25, and a performance information storage table 26. The processor 11 of the monitoring apparatus 10 executes, based on the computer programs, the Main thread 21, the Monitor thread 23, the queue 24 and the Worker thread 25. However, any one of the Main thread 21, the Monitor thread 23, the queue 24 and the Worker thread 25, or a part of processes thereof may be executed by a hardware circuit.

The Main thread 21 receives an instruction from the manager 30, and controls the whole processes of the server information acquiring API processing unit 20. The Main thread 21, e.g., generates the Monitor thread 23 and the Worker thread 25, and acquires the performance information from the performance information storage table 26.

The thread management table 22 is generated by the Main thread 21. The thread management table 22 manages a link between the monitoring target server 40 and the Monitor thread 23. A key for associating the monitoring target server 40 and the Monitor thread 23 with each other may be an IP address and may also be a serial number of the monitoring target server 40.

The Monitor thread 23 controls a process of periodically acquiring the information of the monitoring target server. To be specific, the Monitor thread 23 periodically registers, in the queue 24, the instruction for acquiring the information from the server information acquiring API processing unit.

The Monitor thread 23 is generated in the one-to-one relationship with the monitoring target server by the Main thread 21. The single Monitor thread 23 may be, however, without being limited to the one-to-one relationship, generated with respect to a plurality of monitoring target servers. In this case, the Monitor thread 23 controls the process of acquiring the information from the plurality of monitoring target servers. The Monitor thread 23 is one example of a monitoring process.

The queue 24 manages the instruction for acquiring the information from the monitoring target server. The queue 24 retains the instructions received from the Monitor thread 23, and hands over the instructions from the older to the Worker thread 25. The queue 24 is generated when starting up the Main thread 21. An element count of the queue 24 maybe restricted to, e.g., “1000” in order to restrain the memory usage quantity. A plurality of queues 24 may also be prepared without a number of queue 24 being limited to “1”.

The Worker thread 25 collects server information by communicating with the monitoring target server. The Worker thread 25 has an object for collecting the server information, this object having a larger size than the ordinary object. The Worker threads 25 are generated by a count that is within a predetermined upper limit value.

When increasing the number of Worker threads 25, parallelism is enhanced, resulting in improving a throughput. While on the other hand, such a tradeoff exists as to cause rises of the memory usage quantity and the communication load as well. Therefore, a contrivance is that an upper limit value of the number of Worker threads 25 is calculated beforehand and can be set as a variable value when initialized.

For example, the upper limit value of the number of Worker threads 25 may be given by: “Upper Limit Value of Monitoring Target Servers 40÷(Interval of Server Information Acquiring Instruction of Monitor Thread 23÷Collection Executing Time of Worker Thread 25)”. Note that the upper limit value of the number of Worker threads 25 may also be read from a setting file designated by the user when starting up the server information acquiring API processing unit 20. The Worker thread 25 is one example of a communication process.

The performance information storage table 26 manages the link between the monitoring target server and the collected information. The key for associating the monitoring target server with the collected information may also be a serial number of the monitoring target server. The performance information storage table 26 is one example of a storage unit.

The manager 30 accepts the instruction from the user via the terminal, and controls the respective processing units, e.g., the server information acquiring API processing unit 20 and other equivalent units. The monitoring target server 40 includes a server management mechanism 41 and OS 42. The server management mechanism 41 provides the serial number of the monitoring target server 40 in addition to states instanced by a temperature, a power source and other equivalent states of the monitoring target server 40. The OS 42 provides the server performance information to the monitoring apparatus.

### OPERATIONAL EXAMPLE

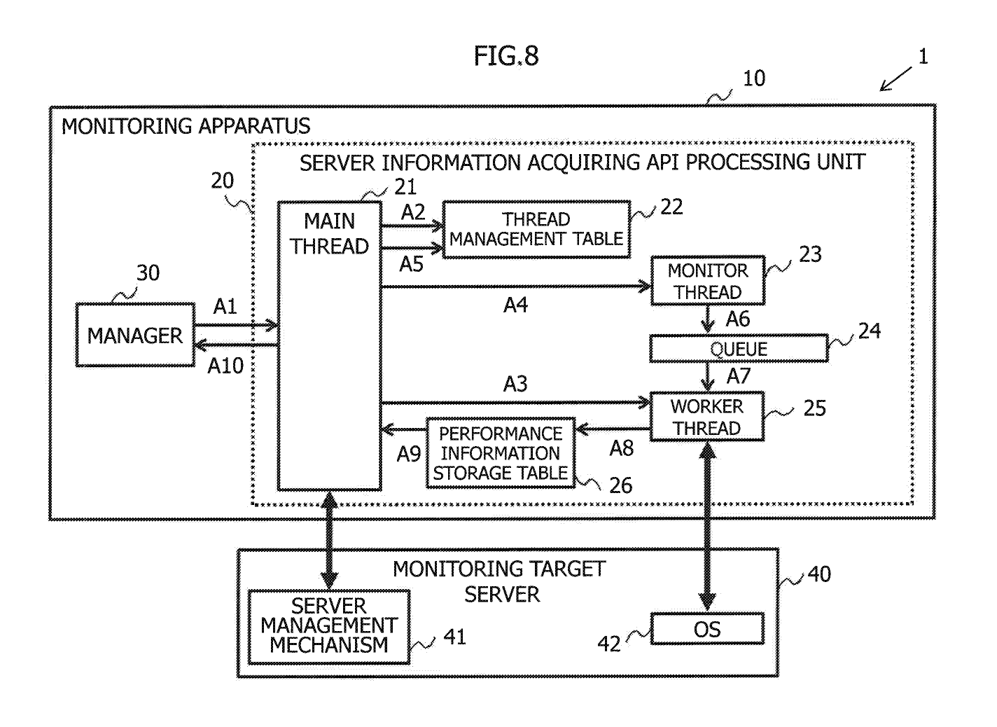

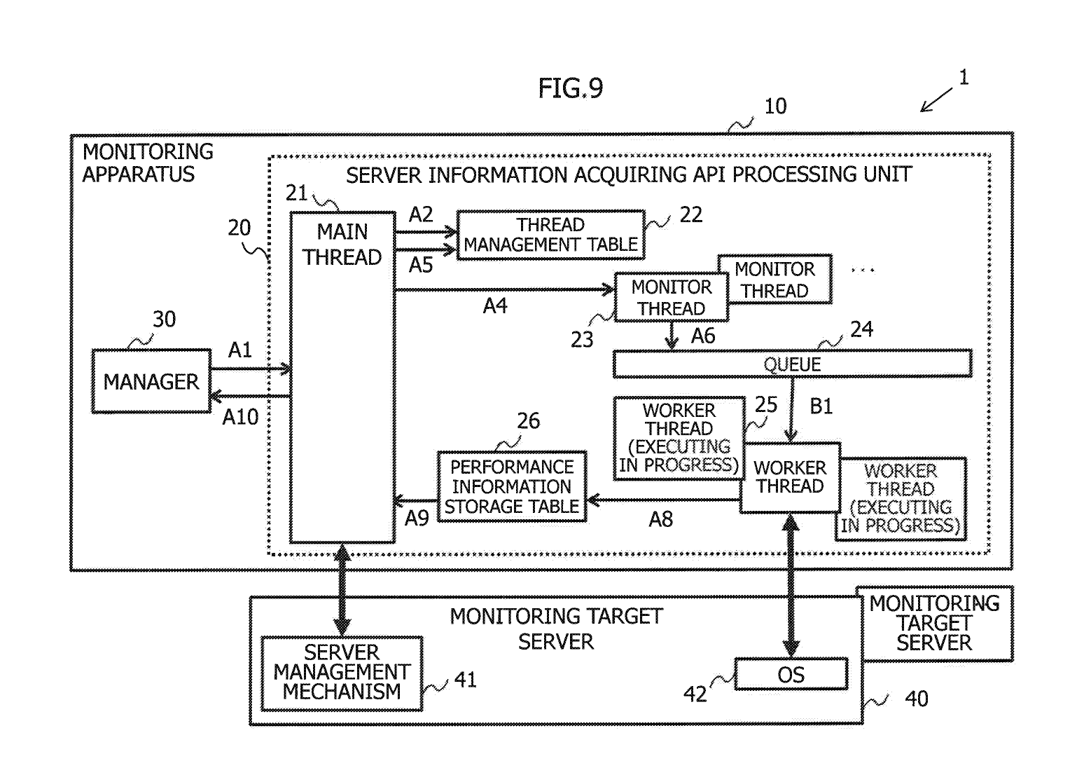

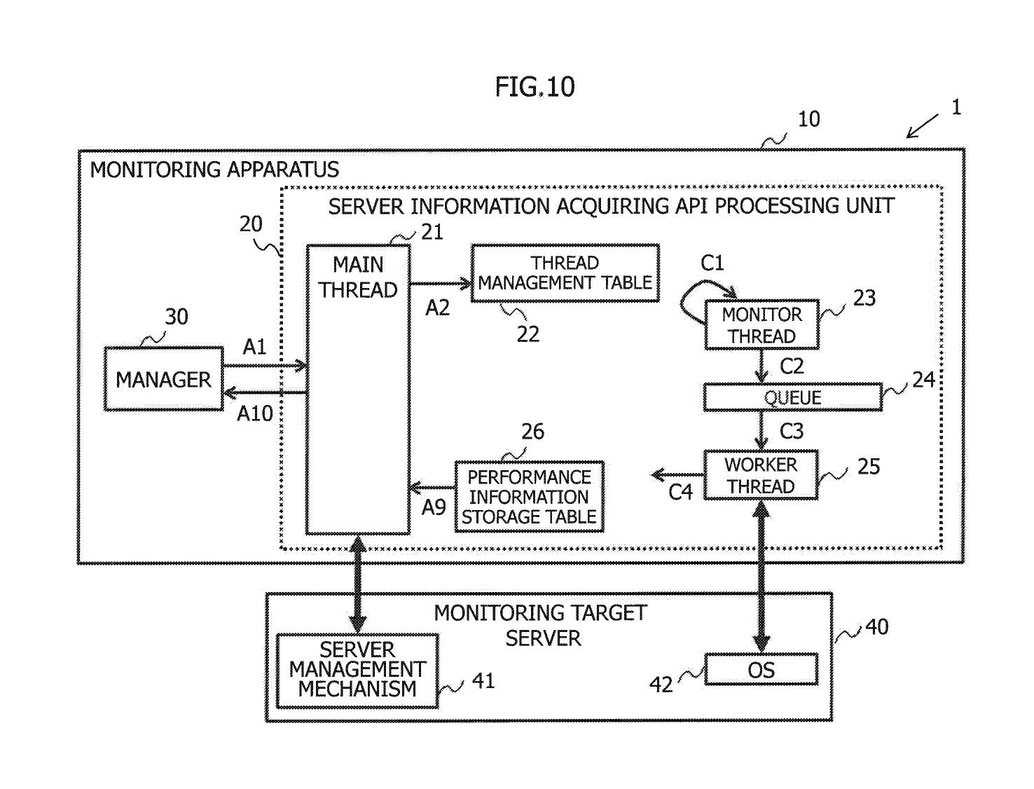

FIGS. 8 through 10 are diagrams each illustrating an operational example of acquiring the server information. FIG. 8 depicts an operation example of acquiring the server information for the first time. FIG. 9 illustrates an operational example when the Worker thread count reaches the upper limit value in acquiring the server information for the first time. FIG. 10 illustrates an operational example of acquiring the server information from the second time onward.

FIG. 8 is a diagram illustrating an operational example of acquiring the server information for the first time. The manager 30 hands over, to the Main thread 21, access information, e.g., an IP address and other equivalent information to the monitoring target server 40 to request the Main thread 21 to acquire the server information (A1). The Main thread 21 checks whether the monitoring target server 40 is registered in the thread management table 22 (A2). The monitoring target server 40 is not registered in the thread management table 22 when accessed for the first time. In this instance, when the number of Worker threads 25 is smaller than the upper limit value, the Main thread 21 generates and starts the Worker thread 25 (A3). The Main thread 21 generates and starts the Monitor thread 23 for the monitoring target server 40 (A4). Further, the Main thread 21 registers the link between the monitoring target server 40 and the generated Monitor thread 23 in the thread management table 22 (A5).

The Monitor thread 23 registers the server information acquiring instruction in the queue (A6). Thereafter, the Monitor thread 23 halts till acquiring the next server information, and releases resources, e.g., the CPU, the memory and other equivalent resources to the system. An event that the thread halts the process for a fixed period of time is referred to also as a “sleep”.

When the server information acquiring instruction is registered in the queue 24, the Worker thread 25 is allocated with the resources to restart the process. An event that the thread restarts the process from the halt status is referred to also as “wake-up”. The Worker thread 25, upon the wake-up, fetches the server information acquiring instruction registered in the queue 24. The Worker thread 25 communicates with the monitoring target server 40 to collect the server information in accordance with the instruction fetched from the queue 24 (A7).

The Worker thread 25 stores the collected server information in the performance information storage table 26 (A8). The Worker thread 25, when the queue 24 contains a next instruction, collects the server information in accordance with the next instruction. Whereas when the queue 24 does not contain the next instruction, the Worker thread 25 sleeps till the next instruction is registered, and releases the resources to the system.

The Main thread 21 fetches the stored server information from the performance information storage table 26 by polling (A9). “Polling” is defined as a communication processing technique for executing the transmission/reception and the process when a fixed condition is satisfied by periodically making a query. The Main thread 21 notifies the manager 30 of the server information fetched from the performance information storage table 26 (A10).

FIG. 9 is a diagram illustrating an operational example when the Worker thread count reaches the upper limit value in acquiring the server information for the first time. Processes exclusive of A3 and A7 are the same as the processes in FIG. 8 and are marked with the same numerals and symbols, and their explanations are omitted.

After the process in A2, when the number of Worker threads 25 reaches the upper limit value, the Main thread 21 does not generate the Worker thread 25. In other words, the Main thread 21 does not execute the process in A3 of FIG. 8.

In A6, when the server information acquiring instruction is registered in the queue 24 and when the Worker thread 25 currently in a sleep status exists, similarly to A7 in FIG. 8, the Worker thread 25 wakes up to collect the server information.

Whereas when any Worker thread 25 currently in the sleep status does not exist and when the respective Worker threads 25 execute the processes in progress, the instructions registered in the queue 24 are not processed till the processes are finished. The Worker thread 25, upon finishing the process, fetches the next instruction registered in the queue 24, and collects the server information in accordance with this instruction (B1).

FIG. 10 is a diagram illustrating an operational example of acquiring the server information from the second time onward. The processes in A1, A2, A9 and A10 are the same as the processes in FIG. 8 and are marked with the same numerals and symbols, and their explanations are omitted. The Monitor thread 23 for the monitoring target server 40 is generated when accessed for the first time and has been started.

After acquiring the server information for the first time, the Monitor thread 23 registers the server information acquiring instruction in the queue 24 at a predetermined time interval (C1, C2). The instruction registered in the queue 24 is fetched by the Worker thread 25 not currently executing the process (C3). The Worker thread 25 having fetched the instruction communicates with the monitoring target server 40 to collect the server information therefrom, and stores the collected server information in the performance information storage table 26. With repetitions of collecting the server information, the server information of the monitoring target servers 40 is accumulated in the performance information storage table 26 (C4).

<Data Structure>

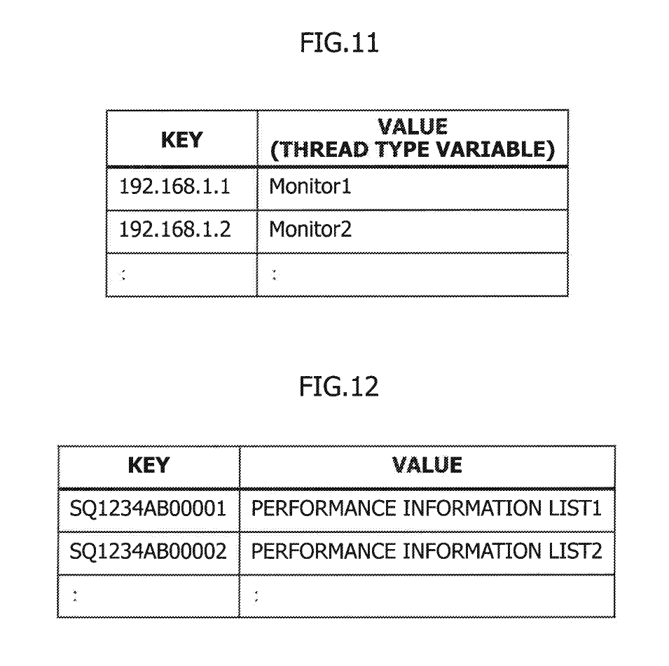

FIGS. 11 through 14 are explanatory diagrams each illustrating a data structure of a table used in the monitoring apparatus 10 and an example of a data structure of the information to be received and transferred between the threads.

FIG. 11 is the diagram depicting one example of a data structure of the thread management table 22. The thread management table 22 manages the link between the monitoring target server 40 and the Monitor thread 23. The thread management table 22 contains a “key” field and a “value” field. An IP address of the monitoring target server 40 is entered in the “key” field. A thread name of the Monitor thread 23 associated with the monitoring target server 40 is entered in the “value” field. A value instanced by a process number and other equivalent values, from which to identify the Monitor thread 23, may also be entered in the “value” field.

In FIG. 11, the monitoring target server 40 having, e.g., an IP address “192.168.1.1” is associated with the Monitor thread 23 having a thread name “Monitor1”. Similarly, the monitoring target server 40 having an IP address “192.168.1.2” is associated with the Monitor thread 23 having a thread name “Monitor2”.

FIG. 12 is the diagram depicting one example of a data structure of the performance information storage table 26. The performance information storage table 26 manages the link between the monitoring target server and the collected server information. The performance information storage table 26 contains a “key” field and a “value” field. A serial number of the monitoring target server 40 is entered in the “key” field. A storage location or a link destination of the performance information list about the monitoring target server 40 is entered in the “value” field.

The server information containing the performance information is periodically collected, and hence the performance information list may retain sets of performance information of a plurality of generations. The performance information of each generation is registered as one entry in the performance information list. In other words, the performance information list has a plurality of entries for registering the performance information of the respective generations.

In FIG. 12, the monitoring target server 40 having, e.g., a serial number “SQ1234AB00001” is associated with the performance information specified by “performance information LIST1”. Similarly, the monitoring target server 40 having, a serial number “SQ1234AB00002” is associated with the performance information specified by “performance information LIST2”.

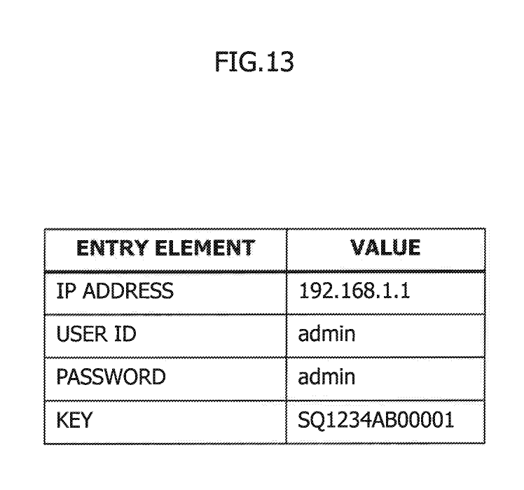

FIG. 13 is a diagram depicting one example of a data structure of an entry to be registered in the queue 24. FIG. 13 illustrates an example of one entry to be registered in the queue 24. Elements of the entry are an “IP address”, a “user ID”, a “password” and a “key”. An IP address of the monitoring target server 40 is entered as the “IP address”. A log-in user ID of the monitoring target server 40 is entered as the “user ID”. A password associated with the user ID is entered as the “password”. A serial number of the monitoring target server 40 is entered as the “key”.

The entry in the queue 24 illustrated in FIG. 13 indicate that the server information is collected from the monitoring target server 40 specified by the IP address “192.168.1.1”. The Worker thread 25 logs in the monitoring target server 40 by entering “admin” as the user ID and “admin” as the password to collect the information. Further, the Worker thread 25 stores the collected performance information in the performance information storage table 26 with the serial number “SQ1234AB00001” being entered as the “key”.

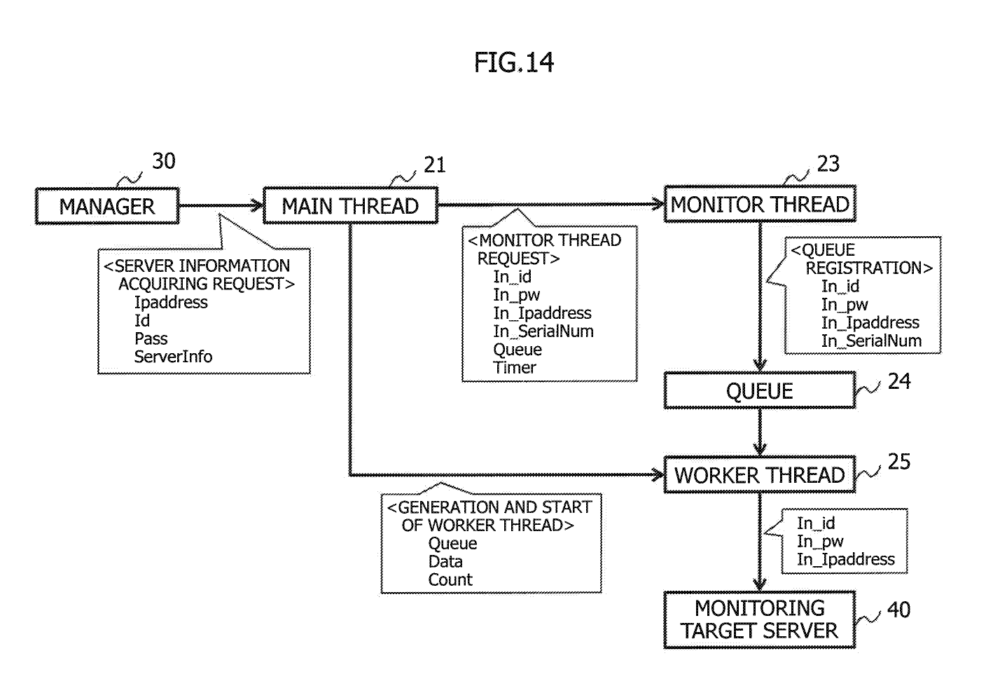

FIG. 14 is a diagram depicting one example of a data structure of information to be received and transferred between the threads. The manager 30, when making the request for acquiring the server information, hands over information containing “Ipaddress”, “Id”, “Pass” and “ServerInfo” to the Main thread 21. “Ipaddress” represents an IP address of the server management mechanism 41 of the monitoring target server 40 from which to request the acquisition of the server information. “Id” is the log-in user ID for the server management mechanism 41 of the monitoring target server 40. “Pass” is a password associated with the log-in user ID. “ServerInfo” is an object containing the OS connecting information.

The Main thread 21, when generating the Monitor thread 23, hands over information containing “In_id”, “In_pw”, “In_Ipaddress”, “In_SerialNum”, “Queue” and “Timer”. “In_id” is the user ID of the OS connecting information. “In_pw” is a password of the OS connecting information. “In_Ipaddress” is an IP address of the OS connecting information. “In_SerialNum” is a serial number of the monitoring target server 40. The serial number is acquired from the server management mechanism 41 of the monitoring target server 40 in the Main thread 21. “Queue” is a name of the queue 24 that registers the server information acquiring instruction. “Timer” is an interval for collecting the server information.

The Main thread 21, when generating and starting the Worker thread 25, hands over the information containing “Queue”, “Data” and “Count” to the Worker thread 25. “Queue” is a name of the queue 24 from which to fetch the server information acquiring instruction. “Data” is the performance information storage table 26 defined as the storage location of the collected server information. “Count” is a generation count of the generations at which the collected server information is saved. The generation count of the generations at which the collected server information is saved may also be read from the setting file designated by the user when starting up the server information acquiring API processing unit 20.

The Monitor thread 23 registers, in the queue 24, an entry containing “In_id”, “In_pw”, “In_Ipaddress” and “In_SerialNum”. “In_id” is a user ID of the OS connecting information. “In_pw” is a password of the OS connecting information. “In_Ipaddress” is an IP address of the OS connecting information. “In_SerialNum” is a serial number of the monitoring target server 40. The Worker thread 25 communicates with the monitoring target server 40 by using “In_id”, “In_pw” and “In_Ipaddress” fetched from the queue 24, thus collecting the server information therefrom.

<Processing Flow>

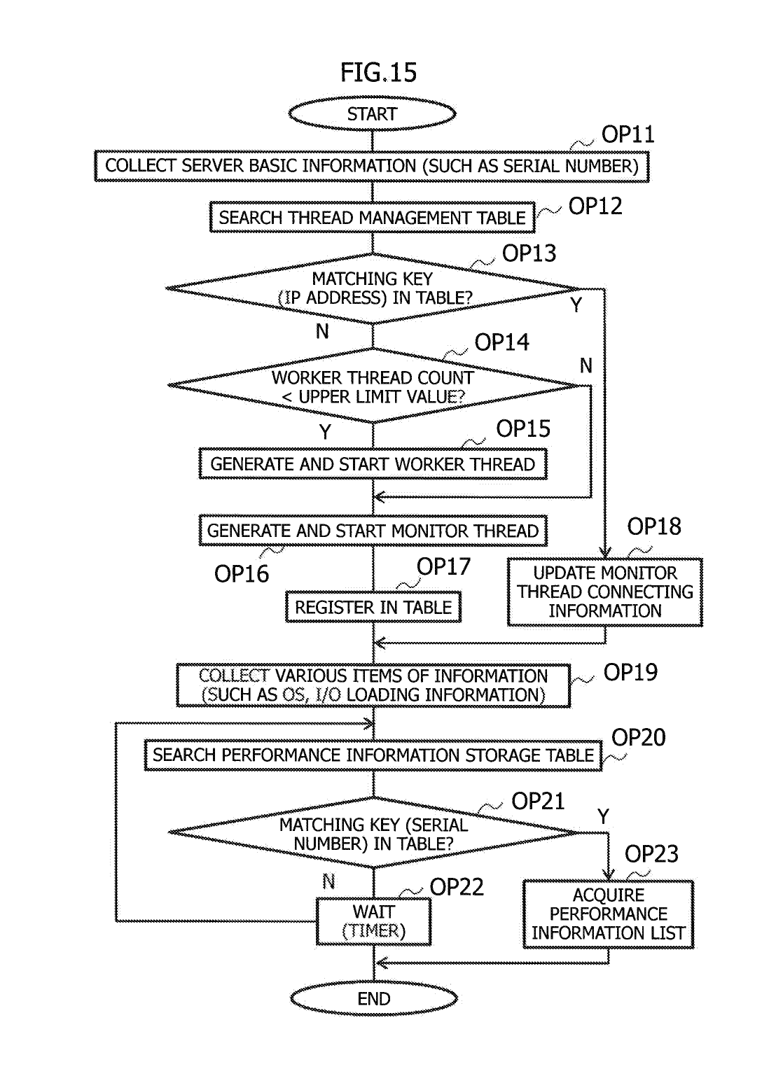

FIGS. 15 through 18 are explanatory diagrams each illustrating a flow of the server information acquiring process by the Main thread 21, the Monitor thread 23 and the Worker thread 25.

FIG. 15 depicts one example of a flowchart of the process of the Main thread 21. A start of the process of the Main thread 21 is triggered upon, e.g., the server information acquiring request given from the manager 30.

In OP11, the Main thread 21 collects server basic information instanced by the serial number and other equivalent information from the server management mechanism 41 of the monitoring target server 40. Next, the processing advances to OP12. In OP12, the Main thread 21 searches the thread management table 22. Subsequently, the processing advances to OP13.

In OP13, the Main thread 21 determines whether or not the thread management table 22 contains a key matching with the IP address of the monitoring target server 40. When the matching key exists (OP13: Y), the processing diverts to OP18. Whereas when any matching key does not exist (OP13: N), the processing advances to OP14.

In OP14, the Main thread 21 determines whether a number of Worker threads 25 is smaller than an upper limit value. When the number of Worker threads 25 is smaller than the upper limit value (OP14: Y), the processing advances to OP15. Whereas when he number of Worker threads 25 is equal to the upper limit value (OP14: N), the processing diverts to OP16.

In OP15, the Main thread 21 generates and starts the Worker thread 25. Next, the processing advances to OP16. In OP16, the Main thread 21 generates and starts the Monitor thread 23. Subsequently, the processing advances to OP17.

In OP17, the Main thread 21 registers the generated Monitor thread 23 in the thread management table 22 by being associated with the monitoring target server 40. Next, the processing advances to OP19.

In OP18, the Main thread 21 updates the connecting information of the Monitor thread 23, which is retained in the thread management table 22. The Main thread 21, when the connecting information remains unchanged, may not update the connecting information of the Monitor thread 23. Subsequently, the processing advances to OP19.

In OP19, the Main thread 21 collects various items of information instanced by OS, Input/Output (I/O) loading information and other equivalent information from the server management mechanism 41 of the monitoring target server 40. Next, the processing advances to OP20.

In OP20, the Main thread 21 searches the performance information storage table 26. Next, the processing advances to OP21. In OP21, the Main thread 21 determines whether the performance information storage table 26 contains a key matching with the serial number of the monitoring target server 40. When the matching key exists (OP21: Y), the processing diverts to OP23. Whereas when the matching key does not exist (OP21: N), the processing advances to OP22.

In OP22, the Main thread 21 loops back to OP20 after a predetermined period of waiting time has elapsed on the timer. In other words, the Main thread 21 repeats the processes in OP20 through OP22 for a period till the Worker thread 25 stores the server information of the monitoring target server 40 in the performance information storage table 26. In OP23, the Main thread 21 acquires a performance information List of the monitoring target server 40, and the processes by the Main thread 21 are finished.

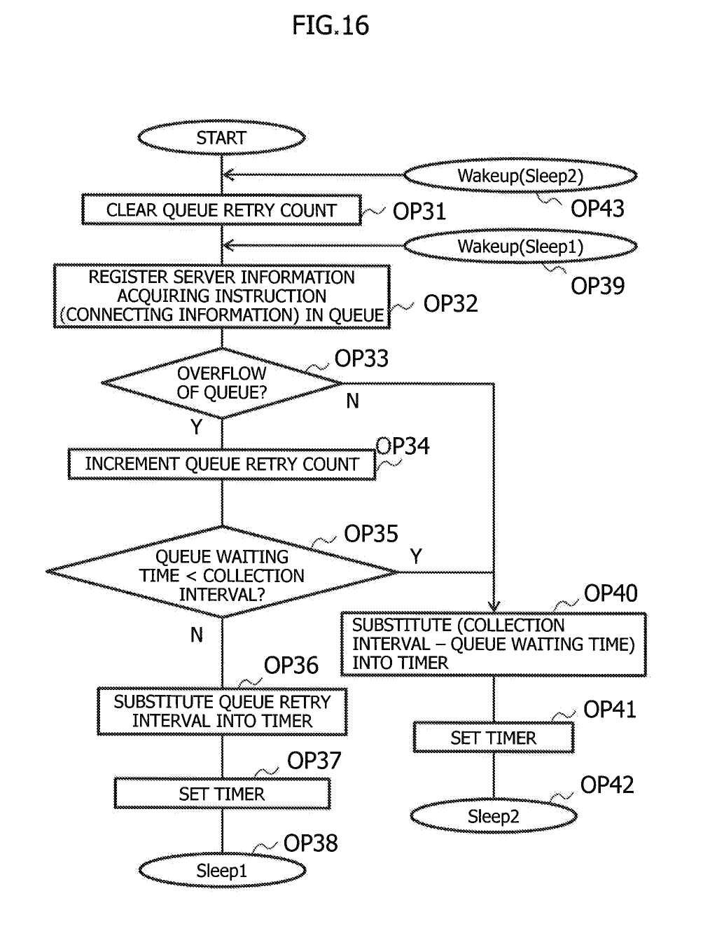

FIG. 16 illustrates one example of a flowchart of a process of the Monitor thread 23. A start of the process of the Monitor thread 23 is triggered by an event that the Main thread 21 generates and starts the Monitor thread 23.

In OP31, the Monitor thread 23 initializes a retry count of a registration process in the queue 24. Next, the processing advances to OP32. In OP32, the Monitor thread 23 registers the server information acquiring instruction containing the connecting information in the queue 24. Subsequently, the processing advances to OP33.

In OP33, the Monitor thread 23 determines whether an overflow of the queue occurs due to the registration process inn OP32. When the overflow of the queue occurs (OP33: Y), the processing advances to OP34. Whereas when the overflow of the queue does not occur (OP33: N), the processing diverts to OP40.

In OP34, the Monitor thread 23 increments the retry count of the registration process in the queue 24 by “1”. Next, the processing advances to OP35. In OP35, the Monitor thread 23 determines whether the waiting time for the queue 24 is shorter than a collection interval of the server information. The waiting time for the queue 24 can be calculated from the retry count and a retry interval to the queue 24. When the waiting time for the queue 24 is shorter than the collection interval of the server information (OP35: Y), the processing diverts to OP40. Whereas when the waiting time for the queue 24 is equal to or longer than the collection interval of the server information (OP35: N), the processing advances to OP36.

In OP36, the Monitor thread 23 substitutes the retry interval of the queue into the timer. Subsequently, the processing advances to OP37. In OP37, the Monitor thread 23 sets the timer to sleep (OP38). When the timer waiting time elapses, the Monitor thread 23 wakes up (OP39), and the processing loops back to OP32.

In OP40, the Monitor thread 23 substitutes “collection interval—queue waiting time” into the timer. Next, the processing advances to OP41. In OP41, the Monitor thread 23 sets the timer to sleep (OP42). When the timer waiting time elapses, the Monitor thread 23 wakes up (OP43), and the processing loops back to OP31.

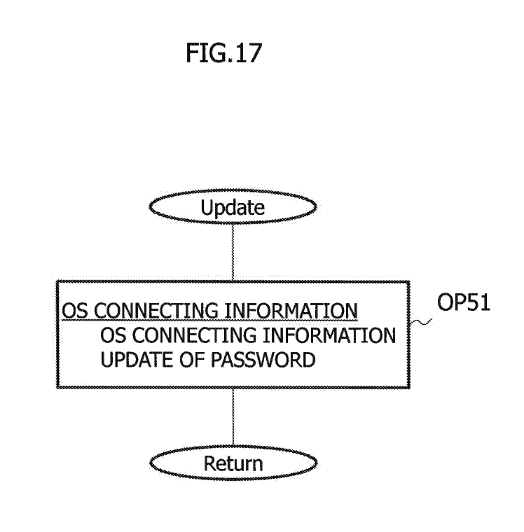

FIG. 17 illustrates one example of a flowchart of a connecting information update process of the Monitor thread 23. Processes in FIG. 17 are details of the process of OP18 in FIG. 15. In OP51, the Monitor thread 23 updates the user ID and the password in the OS connecting information retained in the thread management table 22. The processing loops back to OP19 in FIG. 15.

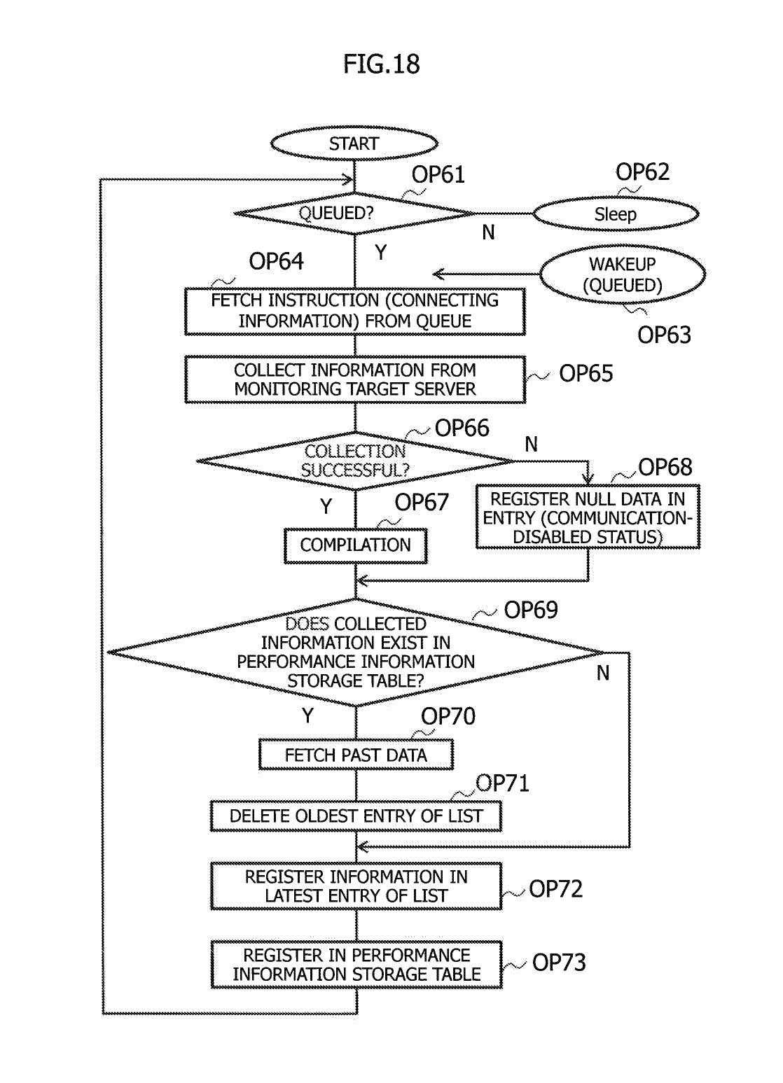

FIG. 18 illustrates one example of a flowchart of the process of the Worker thread 25. A start of the process of the Worker thread 25 is triggered by, e.g., an event that the Monitor thread 23 registers the server information acquiring instruction in the queue 24.

In OP61, the Worker thread 25 determines whether the server information acquiring instruction is registered in the queue 24. When the server information acquiring instruction is registered in the queue 24 (OP61: Y), the processing advances to OP64. Whereas when the server information acquiring instruction is not registered in the queue 24 (OP61: N), the processing diverts to OP62. In OP62, the Worker thread 25 sleeps. When the server information acquiring instruction is registered in the queue 24 (OP63), the processing advances to OP64.

In OP64, the Worker thread 25 fetches the server information acquiring instruction from the queue 24. Subsequently, the processing advances to OP65. In OP65, the Worker thread 25 collects the server information from the monitoring target server 40. Next, the processing advances to OP66.

In OP66, the Worker thread 25 determines whether the collection of the server information becomes successful. When succeeding in collecting the server information (OP66: Y), the processing advances to OP67. Whereas when not succeeding in collecting the server information (OP66: N), the processing diverts to OP68.

In OP67, the Worker thread 25 compiles the collected server information. The compilation of the server information involves compiling the collected items of server information instanced by calculation of a CPU usage rate and other equivalent items into values to be registered in the performance information storage table 26. Subsequently, the processing advances to OP69.

In OP68, the Worker thread 25 enters null data in an entry of the performance information list of the monitoring target server 40. The entry containing the null data indicates a communication-disabled status with the monitoring target server 40. Next, the processing advances to OP69.

In OP69, the Worker thread 25 determines whether the performance information storage table 26 contains the collection information given from the monitoring target server 40. When the collection information given from the monitoring target server 40 already exists (OP69: Y), the processing advances to OP70. Whereas when the collection information given from the monitoring target server 40 does not exist (OP69: N), the processing diverts to OP72.

In OP70, the Worker thread 25 fetches the performance information list containing the information collected in the past. Next, the processing advances to OP71. In OP71, the Worker thread 25 deletes the oldest entry in the performance information list. Note that the number of entries contained in the performance information list is smaller than the predetermined generation count, in which case the Worker thread 25 does not need to delete the oldest entry. Next, the processing advances to OP72.

In OP72, the Worker thread 25 enters the information collected in OP65 in the latest entry in the performance information list. Subsequently, the processing advances to OP73. In OP73, the Worker thread 25 registers the performance information list in the performance information storage table 26. Next, the processing loops back to OP61.

<Operational Effect of Embodiment>

The management thread is generated in the one-to-one relationship with the monitoring target server 40 in order to monitor the monitoring target server 40. The management thread collects the server information by communicating with the monitoring target server 40, and therefore has higher loads instanced by the memory usage quantity, the communication load and other equivalent loads than the thread not involving the communications. Consequently, the load rises as the number of monitoring target servers 40 increases.

In the embodiment, a role of the management thread is shared with the Monitor thread 23 and the Worker thread 25. The Worker thread 25 takes its share of the information collecting process having a higher load than other processes. The number of Worker threads 25 is restricted to a value that is smaller than the number of monitoring target servers 40. When the server information acquiring instructions are given in excess of the number of Worker threads 25, the extra instructions are registered in the queue 24. The extra instructions registered in the queue 24 are fetched and sequentially processed by the Worker threads 25 having finished the processes.

Thus, the monitoring apparatus 10 can restrict a workload per unit time and restrain the resources to be used by collecting the information of the respective monitoring target servers 40 in a way that restricts the number of Worker threads 25. In other words, the monitoring apparatus 10 reuses the resources allocated to the Worker threads 25, thereby enabling the loads, i.e., the memory usage quantity, the communication load and other equivalent loads from being restrained.

In the embodiment, one Worker thread 25 collects the information from the plurality of monitoring target servers 40. Therefore, the collected information is retained in performance information storage table 26 different from the table of the Worker thread 25. The Main thread 21 shares the performance information storage table 26 with the Worker thread 25. Accordingly, the Main thread 21 can fetch the collected information from the performance information storage table 26 asynchronously with the process of the Worker thread 25 without communicating with the Worker thread 25. The Main thread 21 is thereby enabled to give a response to the manager 30 irrespective of whether the Worker thread 25 performs the process in progress, resulting in a reduction of response time. The reduced response time leads to a reduction in time till the collected information is displayed on the screen of the terminal and other equivalent equipment, and to an improved screen display performance.

### MODIFIED EXAMPLE 1

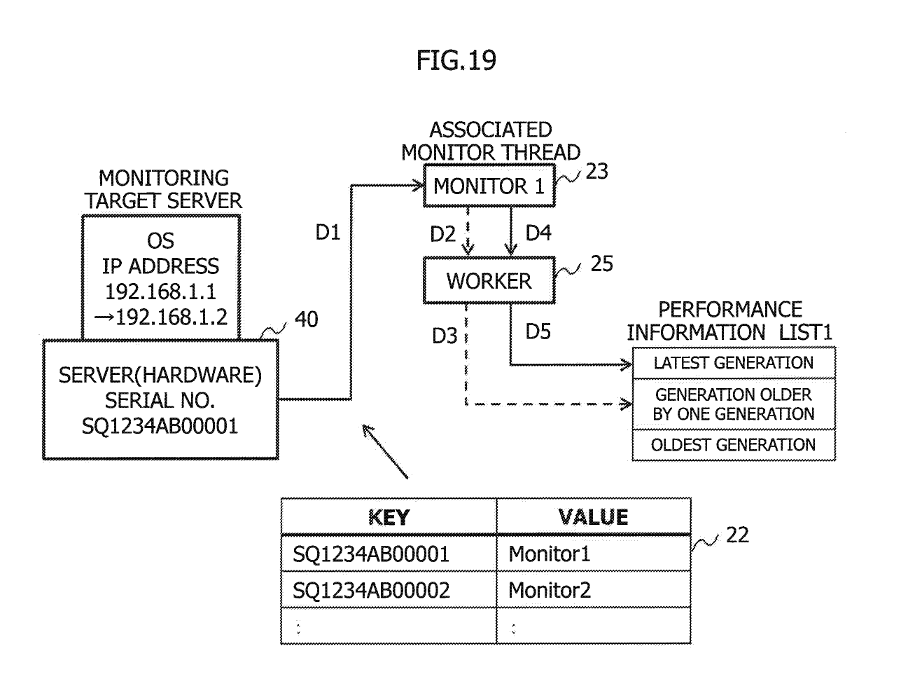

FIG. 19 is a diagram illustrating a modified example 1 in which the monitoring target server 40 is associated with the Monitor thread 23 by the serial number. In FIG. 19, the IP address of the monitoring target server 40 is changed to “192.168.1.2” from “192.168.1.1”. In the thread management table 22, unlike the case in FIG. 11, not the IP address but the serial number is used as the key. The monitoring target server 40 is associated with “Monitor1” specifying the Monitor thread 23 by the serial number “SQ1234AB00001”.

Before changing the IP address, “Monitor 1” (i.e., the Monitor thread 23), upon accepting the server information acquiring request (D1), instructs the Worker thread 25 to collect the information of the monitoring target server 40 (D2). The Worker thread 25 acquires “performance information LIST1” associated with the serial number “SQ1234AB00001” from the performance information storage table 26 depicted in FIG. 12.

The list “performance information LIST1” has performance information entries of three generations, i.e., the latest generation, the generation older by one generation and the oldest generation. The Worker thread 25 registers the performance information acquired from the monitoring target server 40 in the entry of the generation older by one generation (D3). Hereat, the IP address of the monitoring target server 40 is “192.168.1.1” before being changed.

Next, after changing the IP address, “Monitor 1”, when accepting the server information acquiring request (D1), instructs the Worker thread 25 to collect the information of the monitoring target server 40 (D4). Similarly to before changing the IP address, the Worker thread 25 acquires “performance information LIST1”. The serial number remains unchanged even by changing the IP address, and hence the same “performance information LIST1” as before being changed is acquired. The Worker thread 25 registers the performance information acquired from the monitoring target server 40 in the entry of the latest generation (D5). Hereat, the IP address of the monitoring target server 40 is “192.168.1.2” because of being after changing the IP address.

Note that a processing flow in the modified example 1 is substantially the same as the processing flow In FIGS. 15 through 18, and hence the discussion will be focused on different points. In OP13 of FIG. 15, the Main thread 21 determines whether the thread management table 22 contains a key matching with not the IP address but the serial number of the monitoring target server 40. In OP51 of FIG. 17, the Monitor thread 23 updates the IP address in addition to the user ID and the password in the OS connecting information retained in the thread management table 22.

In the modified example 1, the monitoring target server 40 is associated with the Monitor thread 23 by using not the IP address but the serial number as the key. The performance information with the serial number serving as the key is registered in the performance information storage table 26, and therefore the server information of the same monitoring target server 40 can be acquired based on the serial number as the key even when the IP address is changed.

### MODIFIED EXAMPLE 2

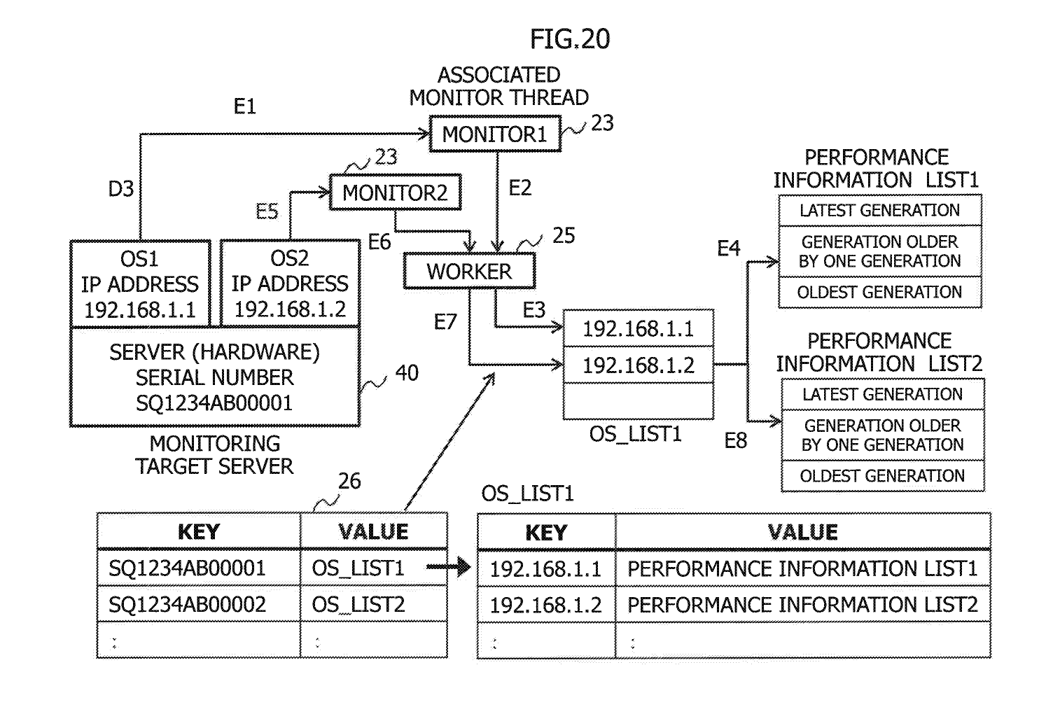

FIG. 20 is a diagram illustrating a modified example 2 in which the monitoring target server 40 includes a plurality of OSs. In FIG. 20, the monitoring target server 40 has OS1 specified by an IP address “192.168.1.1” and OS2 specified by an IP address “192.168.1.2”. The OS1 is associated with “Monitor1” with the reference to the thread management table 22 in FIG. 11. Similarly, the OS2 is associated with “Monitor2”.

The “Monitor1”, upon accepting the server information acquiring request (E1), instructs the Worker thread 25 to collect the information of the monitoring target server 40 (E2). The Worker thread 25 acquires “OS_LIST1” associated with a serial number “SQ1234AB00001” from the performance information storage table 26 (E3). The Worker thread 25 registers the performance information acquired from the monitoring target server 40 in “OS_LIST1” (E4).

Similarly, the “Monitor2”, upon accepting the server information acquiring request (E5), instructs the Worker thread 25 to collect the information of the monitoring target server 40 (E6). The Worker thread 25 acquires “OS_LIST1” associated with a serial number “SQ1234AB00001” from the performance information storage table 26 (E7). The Worker thread 25 registers the performance information acquired from the monitoring target server 40 in “OS_LIST1” (E4).

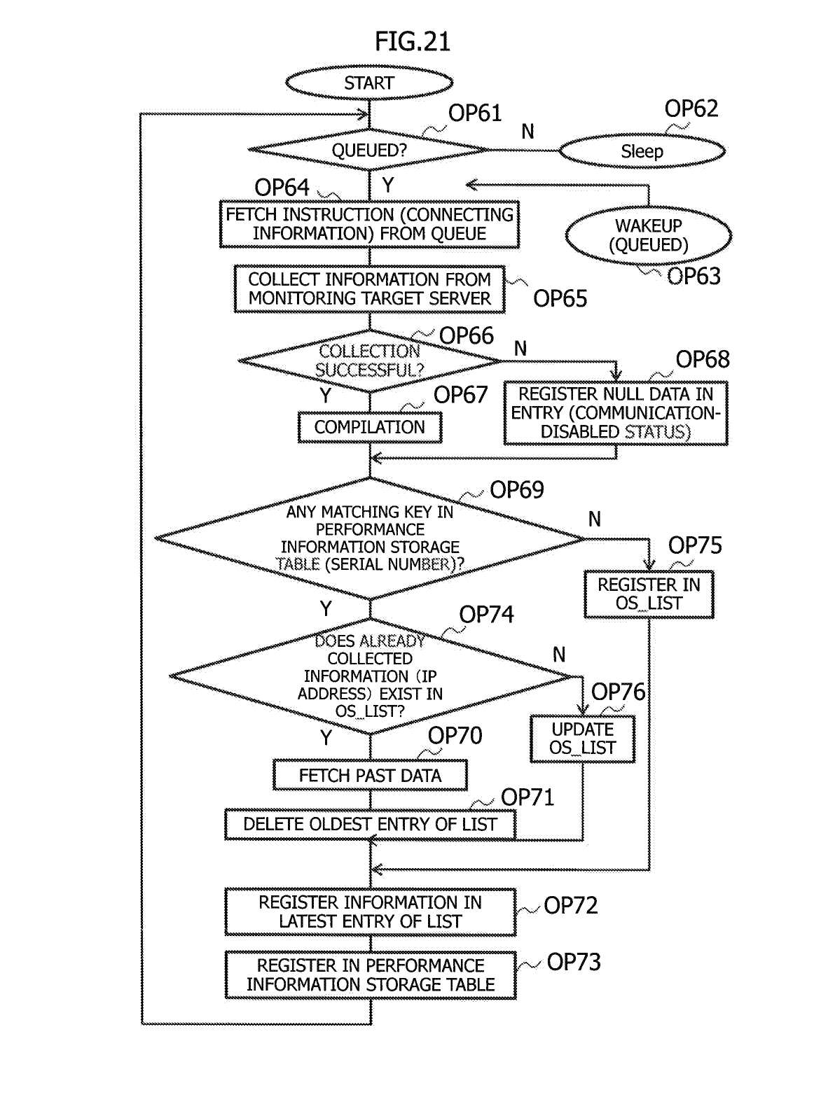

Note that the processing flows of the Main thread 21 and the Monitor thread 23 in the modified example 2 of FIG. 20 are the same as the processing flows in FIG. 15 through 17. The Worker thread 25 is instructed to collect the information of the monitoring target server 40 (E2). FIG. 21 illustrates the processing flow of the Worker thread 25.

FIG. 21 depicts one example of a flowchart of the process of the Worker thread 25 in the modified example 2. Processes in OP61 through OP73 are substantially the same as those in FIG. 18 and are therefore marked with the same numerals and symbols, and their explanations are omitted.

In OP69, the Worker thread 25 determines whether the performance information storage table 26 contains “OS_LIST” associated with the monitoring target server 40. When there exists “OS_LIST” associated with the monitoring target server 40 (OP69: Y), the processing advances to OP74. Whereas when there does not exist “OS_LIST” associated with the monitoring target server 40 (OP69: N), the processing diverts to OP75.

In OP74, the Worker thread 25 determines whether the information collected from the monitoring target server 40 already exists in “OS_LIST” acquired from the performance information storage table 26. When the information collected from the monitoring target server 40 already exists therein (OP74: Y), the processing advances to OP70. Whereas when the information collected from the monitoring target server 40 does not exist therein (OP74: N), the processing diverts to OP76.

In OP75, the Worker thread 25 registers “OS_LIST” associated with the monitoring target server 40 in the performance information storage table 26. The IP address of the OS held by the monitoring target server 40 is registered in “OS_LIST”. Next, the processing advances to OP72. In OP76, the Worker thread 25 updates “OS_LIST” associated with the monitoring target server 40 into a latest status. Next, the processing advances to OP72.

In the modified example 2, when the monitoring target server 40 includes the plurality of OSs, the Monitor threads 23 associated with the respective OSs are generated. The performance information list per OS is generated via “OS_LIST”. The server information can be thereby acquired even when the monitoring target server 40 includes the plurality of OSs.

The monitoring apparatus and the information processing system of the disclosure can reduce the load on the monitoring apparatus monitoring the plurality of servers interconnected via the network.

<Non-Transitory Recording Medium>

A program for making a computer, other machines and apparatuses (which will hereinafter be referred to as the computer and other equivalent apparatuses) attain any one of the functions can be recorded on a non-transitory recording medium readable by the computer and other equivalent apparatuses. The computer and other equivalent apparatuses are made to read and execute the program on this non-transitory recording medium, whereby the function thereof can be provided.

Herein, the non-transitory recording medium readable by the computer and other equivalent apparatuses connotes a non-transitory recording medium capable of accumulating information instanced by data, programs and other equivalent information electrically, magnetically, optically, mechanically or by chemical action, which can be read from the computer and other equivalent apparatuses. Among these non-transitory recording mediums, the mediums removable from the computer and other equivalent apparatuses are exemplified by a flexible disc, a magneto-optic disc, a CD-ROM, a CD-R/W, a DVD, a Blu-ray disc, a DAT, an 8 mm tape, and a memory card like a flash memory. A hard disc, a ROM and other equivalent recording mediums are given as the non-transitory recording mediums fixed within the computer and other equivalent apparatuses. Still further, a solid state drive (SSD) is also available as the non-transitory recording medium removable from the computer and other equivalent apparatuses and also as the non-transitory recording medium fixed within the computer and other equivalent apparatuses.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A monitoring apparatus comprising:
one or more processors configured to execute a plurality of monitoring processes generated for a plurality of monitoring target information processing apparatuses and communication processes generated by a count smaller than a number of the plurality of monitoring target information processing apparatuses,
wherein each of the plurality of monitoring processes causes the one or more processors to register an instruction of collecting information from a monitoring target information processing apparatus in a queue, and each of the communication processes causes the one or more processors to read the instruction registered in the queue, to collect monitored information from the monitoring target information processing apparatus, and to write the monitored information into a storage unit.

2. The monitoring apparatus according to claim 1, further comprising a display configured to display the monitored information acquired from the storage unit.

3. An information processing system comprising:
a monitoring apparatus; and
a plurality of monitoring target information processing apparatuses,
the monitoring apparatus including:
one or more processors configured to execute a plurality of monitoring processes generated for a plurality of monitoring target information processing apparatuses and communication processes generated by a count smaller than a number of the plurality of monitoring target information processing apparatuses,
wherein each of the plurality of monitoring processes causes the one or more processors to register an instruction of collecting information from a monitoring target information processing apparatus in a queue, and each of the communication processes causes the one or more processors to read the instruction registered in the queue, to collect monitored information from the monitoring target information processing apparatus, and to write the monitored information into a storage unit.

4. A computer-readable recording medium having stored therein a program for causing a computer to execute a monitoring process comprising:
executing a plurality of monitoring processes generated for a plurality of monitoring target information processing apparatuses, each of the plurality of monitoring processes causing the computer to register an instruction of collecting information from a monitoring target information processing apparatus in a queue; and
executing communication processes generated by a count smaller than a number of the plurality of monitoring target information processing apparatuses, each of the communication processes causing the computer to read the instruction registered in the queue, to collect monitored information from the monitoring target information processing apparatus, and to write the monitored information into a storage unit.
